(19) United States
(12) Patent Application Publication
(10) Pub. No.: US 2006/0283198 A1
(43) Pub. Date: Dec. 21, 2006

(54) Apparatus and method for controlling operation of unitary air conditioner

(75) Inventors: Chan Ho Song, Koyang-si (KR); Seung Youp Hyun, Seoul (KR); Jeong Taek Park, Ansan-si (KR); Seung Woo Kang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/373,106

(22) Filed: Mar. 13, 2006

(30) Foreign Application Priority Data
Jun. 15, 2005 (KR) 2005-0051414

(51) Int. Cl. F25B 49/00; G01M 1/38

(52) U.S. Cl. 62/228.1; 700/276

(57) ABSTRACT

An apparatus and a method for controlling the operation of a unitary air conditioner, which diversify signals to be transmitted using existing connection lines for transmitting signals by adjusting an interval between ON and OFF signals, etc., thereby allowing the unitary air conditioner to be operated in various modes.

### BACKGROUND OF THE INVENTION

1. Field of the Invention

The present invention relates to a unitary air conditioner, and more particularly to an apparatus and a method for controlling the operation of a unitary air conditioner, which performs various modes using connection lines between a thermostat or an indoor unit and an outdoor unit.

2. Description of the Related Art

FIG. 1 is a control block diagram of a conventional 1-stage unitary air conditioner, illustrating connection states among important connection lines.

As shown in FIG. 1, the 1-stage unitary air conditioner receives an operation signal (Y) or a stop signal from a 1-stage thermostat 11 which is installed indoors, and operates a 1-stage indoor unit 13 and a 1-stage outdoor unit 15 according to the received signal.

The above 1-stage unitary air conditioner is used in most houses of North America including U.S. A compressor of the 1-stage outdoor unit 15 can be switched on and off without changing the capacity thereof by ON and OFF instructions of the 1-stage thermostat 11.

Here, the 1-stage indoor unit 13 comprises an indoor fan, and the 1-stage outdoor unit 15 comprises the compressor and an outdoor fan.

The 1-stage thermostat 11, the 1-stage indoor unit 13, and the 1-stage outdoor unit 15 are connected by a connection line 17 so that they transmit control signals to each other.

FIG. 2 is a control block diagram of a conventional 2-stage unitary air conditioner, illustrating connection states among important connection lines.

As shown in FIG. 2, the conventional 2-stage unitary air conditioner comprises a 2-stage thermostat 21, and a 2-stage indoor unit 23 and a 2-stage outdoor unit 25 which are operated at different capacities by a strong signal (Y2) or a weak signal (Y1) of the 2-stage outdoor unit 21.

In the 2-stage unitary air conditioner, the 2-stage thermostat 21, the 2-stage indoor unit 23, and the 2-stage outdoor unit 25 are connected by connection lines 27 so that they transmit control signals to each other.

Since the 1-stage thermostat 11, the 1-stage indoor unit 13, and the 1-stage outdoor unit 15 are connected to each other by one connection line 17 so that they transmit only ON and OFF signals to each other through the connection line 17, the above conventional 1-stage unitary air conditioner can operate at most two modes, thus being incapable of operating various modes more than these two modes.

Further, since the 2-stage thermostat 21, the 2-stage indoor unit 23, and the 2-stage outdoor unit 25 are connected to each other by two connection lines 27, the above conventional 2-stage unitary air conditioner can operate at most three modes, such as a weak mode (Y1), a middle mode (Y2), and a strong mode (Y1+Y2). However, the 2-stage unitary air conditioner cannot operate other modes more than these three modes, thus having a limit in operating various modes.

In order to solve the above problem, connection lines for transmitting control signals may be added to the conventional 1-stage or 2-stage air conditioner. When these connection lines are added to the conventional 1-stage or 2-stage air conditioner, a procedure for installing the additional connection lines having the same structure as that of the existing connection lines connected to the inside of an indoor or outdoor wall is required, thereby causing an inconvenience to working persons.

### SUMMARY OF THE INVENTION

Therefore, the present invention has been made in view of the above problems, and it is an object of the present invention to provide an apparatus and a method for controlling the operation of a unitary air conditioner, which diversifies signals transmitted through connection lines and performs various modes using existing connection lines for transmitting signals without any additional connection line.

In accordance with one aspect of the present invention, the above and other objects can be accomplished by the provision of an apparatus for controlling the operation of a unitary air conditioner comprising: an operation signal generating unit for outputting signals for controlling the operation of the unitary air conditioner corresponding to predetermined air conditioner modes using a switch-ON/OFF method; and an operation controller for analyzing the signals of the operation signal generating unit and controlling the operation of the unitary air conditioner in a plurality of modes.

The operation signal generating unit may output the signals corresponding to the air conditioner modes by the number of the ON and OFF signals which are repeated during a designated length of time.

The operation signal generating unit may output the signals corresponding to the air conditioner modes by a difference of lengths of maintaining times between the ON and OFF signals which are repeated during a designated length of time.

The operation signal generating unit may output the signals corresponding to the air conditioner modes by the length of time of the ON or OFF signal which is repeated during a designated length of time.

The operation signal generating unit may be provided in at least one of a thermostat, an indoor unit, and a distributor of the unitary air conditioner.

The operation controller may be provided in an outdoor unit of the unitary air conditioner.

The operation controller may control modes of compressors provided in an outdoor unit of the unitary air conditioner.

The apparatus may further comprise one connection line connected between a thermostat or an indoor unit and an outdoor unit of the unitary air conditioner.

The apparatus may further comprise two connection lines connected between a thermostat or an indoor unit and an outdoor unit of the unitary air conditioner.

In accordance with another aspect of the present invention, there is provided an apparatus for controlling the operation of a unitary air conditioner comprising: an operation signal generating unit for outputting signals for controlling the operation of the air conditioner corresponding to predetermined air conditioner modes using a switch-ON/OFF method; an operation controller for analyzing the signals of the operation signal generating unit and controlling the operation of the unitary air conditioner in a plurality of modes; and at least one connection line connected between the operation signal generating unit and the operation controller for transmitting the signals between the operation signal generating unit and operation controller.

The operation signal generating unit may output the signals corresponding to the air conditioner modes by the number of the ON and OFF signals which are repeated during a designated length of time.

The operation signal generating unit may output the signals corresponding to the air conditioner modes by a difference of lengths of maintaining times between the ON and OFF signals which are repeated during a designated length of time.

The operation signal generating unit may output the signal corresponding to the air conditioner modes by the length of time of the ON or OFF signal which is repeated during a designated length of time.

The operation signal generating unit may be provided in at least one of a thermostat, an indoor unit, and a distributor of the unitary air conditioner.

The operation controller may be provided in an outdoor unit of the unitary air conditioner.

The operation controller may control modes of compressors provided in an outdoor unit of the unitary air conditioner.

In accordance with another aspect of the present invention, there is provided a method for controlling the operation of a unitary air conditioner using the above apparatus, comprising: allowing the operation controller to analyze an OFF signal, when the operation signal generating unit continuously outputs the OFF signal during more than a designated length of time, and to stop operation of compressors of the unitary air conditioner; allowing the operation controller to analyze an ON signal, when the operation signal generating unit continuously outputs the ON signal during more than a designated length of time, and to operate the compressors in a standard mode; and allowing the operation controller to analyze the ON and OFF signals, when the operation signal generating unit repeatedly outputs the ON and OFF signals during more than a designated length of time, and to operate the compressors in an additional mode.

The operation signal generating unit may output the signals corresponding to the air conditioner modes by the number of the ON and OFF signals which are repeated during a designated length of time.

The operation signal generating unit may output the signals corresponding to the air conditioner modes by an interval between the ON and OFF signals which are repeated during a designated length of time.

The operation signal generating unit may output the signals corresponding to the air conditioner modes by a difference of lengths of maintaining times between the ON and OFF signals which are repeated during a designated length of time.

The operation signal generating unit may output the signals corresponding to the air conditioner modes by the length of time of the ON or OFF signal which is repeated during a designated length of time.

The apparatus and the method of the present invention diversify signals to be transmitted using existing connection lines for transmitting signals by adjusting an interval between ON and OFF signals, etc., thereby allowing the unitary air conditioner to be operated in various modes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a control block diagram of a conventional 1-stage unitary air conditioner;

FIG. 2 is a control block diagram of a conventional 2-stage unitary air conditioner;

FIG. 3 is a block diagram of an apparatus for controlling the operation of a unitary air conditioner in accordance with a first embodiment of the present invention;

FIG. 4 is a block diagram of an apparatus for controlling the operation of a unitary air conditioner in accordance with a second embodiment of the present invention;

FIG. 5 is a block diagram of an apparatus for controlling the operation of a unitary air conditioner in accordance with a third embodiment of the present invention; and

FIG. 6 is a block diagram of an apparatus for controlling the operation of a unitary air conditioner in accordance with a fourth embodiment of the present invention.

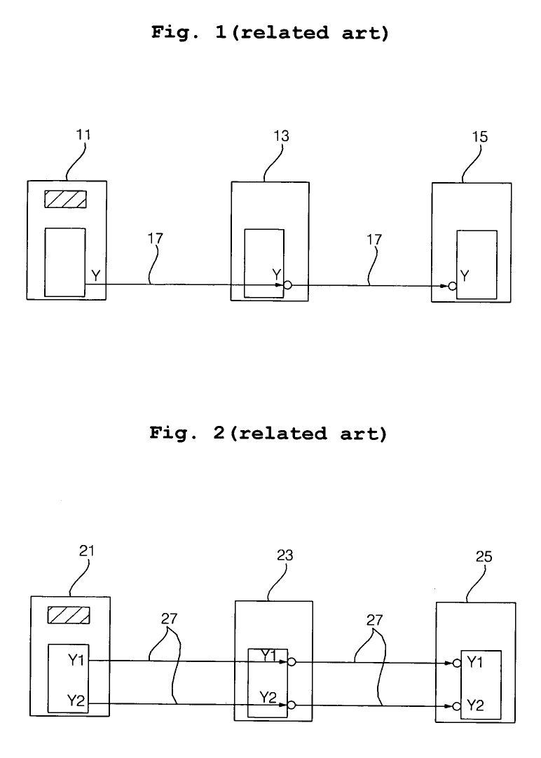

### DESCRIPTION OF THE PREFERRED EMBODIMENTS

Now, preferred embodiments of the present invention will be described in detail with reference to the annexed drawings.

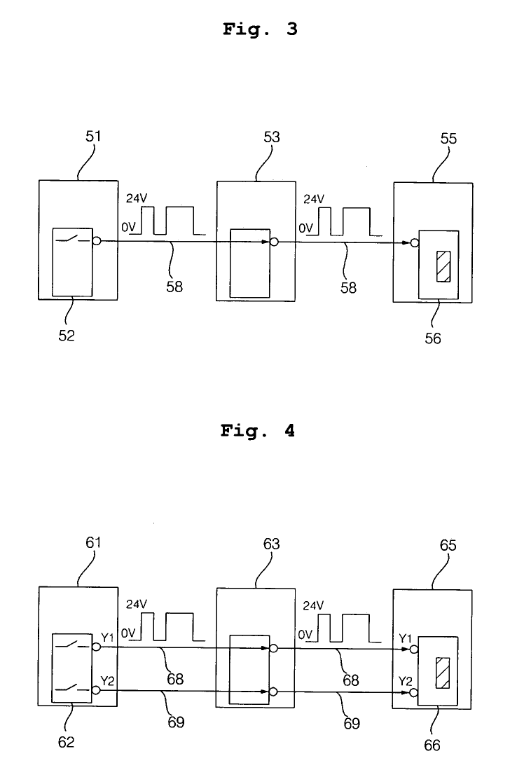

FIG. 3 is a block diagram of an apparatus for controlling the operation of a unitary air conditioner in accordance with a first embodiment of the present invention.

As shown in FIG. 3, the first embodiment of the present invention is applied to a conventional 1-stage unitary air conditioner, and an operation signal generating unit 52 is provided in a thermostat 51 of the unitary air conditioner in accordance with the first embodiment of the present invention.

The unitary air conditioner in accordance with the first embodiment of the present invention has a similar constitution to that of the conventional 1-stage unitary air conditioner. That is, the above unitary air conditioner comprises the thermostat 51 which is installed indoors, and an indoor unit 53 and an outdoor unit 55 which are operated by an operation signal outputted from the thermostat 51, i.e., an ON signal, or a stop signal outputted from the thermostat 51, i.e., an OFF signal.

The thermostat 51 comprises the operation signal generating unit 52 for outputting an air conditioner operation control signal using a switch-ON/OFF method. The operation signal generating unit 52 includes relay switches or semiconductor switches for applying or removing an AC voltage to generate ON and OFF signals.

When the operation signal generating unit 52 outputs the operation signal of the air conditioner according to an air conditioner operation setting mode, the operation signal generating unit 52 continuously outputs the ON signal during a designated length of time, or repeatedly outputs the ON signal and the OFF signal during a designated length of time, thereby allowing the air conditioner to be operated.

For example, when the operation signal generating unit 52 continuously outputs the ON signal during a designated length of time, the air conditioner is driven in a strong mode, i.e., a standard mode, and when the operation signal generating unit 52 repeatedly outputs the ON signal and the OFF signal during a designated length of time, the air conditioner is driven in a weak mode or a middle mode, i.e., in an additional mode.

In the additional mode, the air conditioner is driven in one or more modes according to an interval between the ON signal and the OFF signal, which are repeated during a designated length of time.

For example, the mode of the air conditioner is set by the numbers of the ON and OFF signals which are repeated during a designated length of time. That is, the mode of the air conditioner is set correspondingly to the number of the inputted ON signals for a unit time.

Further, the mode of the air conditioner can be set by a difference of lengths of times between the ON and OFF signals which are repeated during a designated length of time.

Moreover, the mode of the air conditioner can be set correspondingly to the length of time of the ON or OFF signal which is repeated during a designated length of time.

As described above, the operation signal generating unit 52 not only generates the ON signal and OFF signal, but also adjusts the interval between the ON and OFF signals or the lengths of the times of the ON and OFF signals, thereby generating various communication protocols through a plurality of signals. Thus, the operation signal operating unit 52 allows the air conditioner to be operated in various modes.

Further, when the operation signal generating unit 52 continuously outputs the OFF signal during more than a designated length of time, the operation of the air conditioner is stopped.

The indoor unit 53 comprises an indoor fan (not shown). Preferably, the indoor fan is operated in various modes according to various operation control signals outputted from the thermostat 51.

The outdoor unit 55 comprises at least one compressor (not shown) driven in a plurality of modes according to the signals outputted from the operation signal generating unit 52. That is, the outdoor unit 55 may comprise at least one inverter-type compressor, the capacity of which is variable so that the compressor can be operated in plural modes, or comprise a plurality of constant-speed compressors.

Particularly, the outdoor unit 55 further comprises an operation controller 56, which controls the operation of the air conditioner by receiving the signal outputted from the operation signal generating unit 52 of the thermostat 51, analyzing the interval of output times between the ON and OFF signals, and operating the compressor(s) in plural modes according to the analyzed results.

That is, the operation controller 56 analyzes the ON and OFF signals outputted from the operation signal generating unit 52, and operates the compressor(s) in the standard mode when the ON signal is continuously outputted from the operation signal generating unit 52 during a designated length of time, and operates the compressor(s) in the additional mode when the ON and OFF signals are repeatedly outputted from the operation signal generating unit 52 during a designated length of time. Further, the operation controller 56 stops the operation of the compressor(s) when the OFF signal is continuously outputted from the operation signal generating unit 52 during a designated length of time.

In the same as the conventional 1-stage unitary air conditioner, one connection line 58 for transmitting the ON and OFF signals is provided between the operation signal generating unit 52 of the thermostat 51 and the operation controller 56 of the outdoor unit 55.

The unitary air conditioner of this embodiment, which uses the same fundamental constitution as that of the conventional 1-stage unitary air conditioner, generates the ON and OFF signals from the thermostat 51 in various modes, and transmits the obtained communication protocol to the operation controller 56 through one connection line 58, thereby operating the compressor(S) in various modes more than two modes, such as the standard mode and the additional mode.

Hereinafter, a method for controlling the operation of the above unitary air conditioner in accordance with the first embodiment of the present invention will be described.

When the OFF signal is continuously outputted from the operation signal generating unit 52 of the thermostat 51 during more than a designated length of time, the operation controller 56 of the outdoor unit 55 analyzes the OFF signal, and stops the operation of the compressor(s).

When the ON signal is continuously outputted from the operation signal generating unit 52 of the thermostat 51 during more than a designated length of time, the operation controller 56 of the outdoor unit 55 analyzes the ON signal, and operates the compressor(s) in the standard mode (for example, in the strong mode).

When the ON and OFF signals are repeatedly outputted from the operation signal generating unit 52 of the thermostat 51 during more than a designated length of time, the operation controller 56 of the outdoor unit 55 analyzes the ON and OFF signals, and operates the compressor(s) in the additional mode (for example, in the weak or middle mode).

Here, the additional mode includes a plurality of modes, which are divided according to the numbers of the ON and OFF signals repeatedly outputted from the operation signal generating unit 52 within a designated length of time or the interval between the ON and OFF signals.

That is, as described above, the additional mode includes various modes according to the numbers of the ON and OFF signals which are repeated during a designated length of time, the difference of lengths of time between the ON and OFF signals which are repeated during a designated length of time, or the length of time of the ON or OFF signal which is repeated during a designated length of time.

FIG. 4 is a block diagram of an apparatus for controlling the operation of a unitary air conditioner in accordance with a second embodiment of the present invention.

As shown in FIG. 4, the second embodiment of the present invention is applied to a conventional 2-stage unitary air conditioner, and an operation signal generating unit 62 is provided in a thermostat 61 of the unitary air conditioner in accordance with the second embodiment of the present invention.

Differing from the unitary air conditioner in accordance with the first embodiment, the unitary air conditioner in accordance with the second embodiment comprises two connection lines 68 and 69 provided among the thermostat 61, an indoor unit 63, and an outdoor unit 65.

The thermostat 61 comprises the operation signal generating unit 62 for outputting an air conditioner operation control signal using a switch-ON/OFF method through the two connection lines 68 and 69. The operation signal generating unit 62 includes a plurality of relay switches or semiconductor switches for applying or removing an AC voltage to generate ON and OFF signals.

The outdoor unit 65 comprises an operation controller 66, which controls the operation of the air conditioner by receiving the signal outputted from the operation signal generating unit 62 of the thermostat 61 through the two connection lines 68 and 69, analyzing the interval of output times between the ON and OFF signals, and operating compressor(s) in plural modes according to the analyzed results.

In this embodiment, the operation signal generating unit 62 outputs the ON or OFF signal respectively through the Y1 connection line 68 and the Y2 connection line 69. At least one of the Y1 connection line 68 and the Y2 connection line 69 adjusts the interval of output times between the ON and OFF signals in the same manner as the additional mode of the first embodiment, thereby allowing the unitary air conditioner of the second embodiment to be operated in various modes.

Accordingly, the operation signal generating unit 62 of the unitary air conditioner of this embodiment generates three modes, i.e., a Y1 standard mode, a Y2 standard mode, and a Y3 standard mode, through the combination of the Y1 connection line 68 and the Y2 connection line 69 in the same manner as the conventional 2-stage unitary air conditioner, and adjusts the interval of output times between the ON and OFF signals through the Y1 connection line in the same manner as the unitary air conditioner of the first embodiment, thereby allowing the unitary air conditioner of the second embodiment to be operated in at least one additional mode.

The generation of the additional mode is not limited to the use of the Y1 connection line 68, but may be achieved using the Y2 connection line 69 or both the Y1 and Y2 connection lines 68 and 69.

Accordingly, the unitary air conditioner of this embodiment has the same fundamental constitution as that of the conventional 2-stage unitary air conditioner, and can be operated in various modes more than three modes.

A constitution of the unitary air conditioner of the second embodiment except for the above components, and a method for controlling the operation of the above unitary air conditioner are the same as those of the unitary air conditioner of the first embodiment, and a detailed description thereof will thus be omitted.

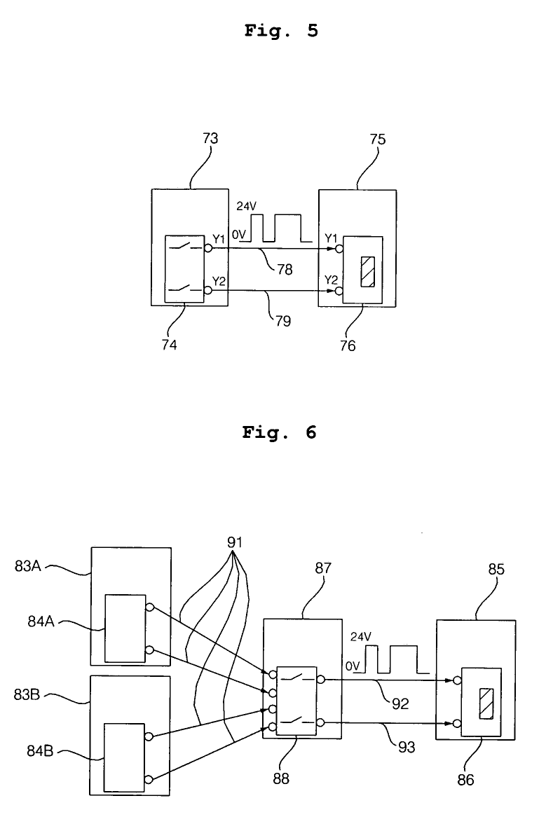

FIG. 5 is a block diagram of an apparatus for controlling the operation of a unitary air conditioner in accordance with a third embodiment of the present invention.

As shown in FIG. 5, the third embodiment of the present invention is applied to a conventional 2-stage unitary air conditioner, and an operation signal generating unit 74 is provided in an indoor unit 73 of the unitary air conditioner in accordance with the third embodiment of the present invention.

Differing from the unitary air conditioner in accordance with the second embodiment, the unitary air conditioner in accordance with the third embodiment does not comprise a thermostat, and comprises the indoor unit 73 provided with the operation signal generating unit 74, an outdoor unit 75 provided with an operation controller 76, and two connection lines 78 and 79 provided between the indoor unit 73 and the outdoor unit 75.

The operation signal generating unit 74 of the indoor unit 73 includes a plurality of relay switches or semiconductor switches for applying or removing an AC voltage to generate ON and OFF signals.

Identically with the unitary air conditioner of the second embodiment, the unitary air conditioner of the third embodiment has the same fundamental constitution as that of the conventional 2-stage unitary air conditioner, and can be operated in various modes more than three modes.

A constitution of the unitary air conditioner of the third embodiment except for the above components, and a method for controlling the operation of the above unitary air conditioner are the same as those of the unitary air conditioner of the first embodiment, and a detailed description thereof will thus be omitted.

FIG. 6 is a block diagram of an apparatus for controlling the operation of a unitary air conditioner in accordance with a fourth embodiment of the present invention.

As shown in FIG. 6, the fourth embodiment of the present invention is applied to a multi-type 2-stage unitary air conditioner, and an operation signal generating unit 88 is provided in a distributor 87 of the unitary air conditioner in accordance with the fourth embodiment of the present invention.

That is, the fourth embodiment of the present invention is applied to a multi-type 2-stage unitary air conditioner, which comprises one outdoor unit 85 and a plurality of indoor units 83A and 83B connected to the outdoor unit 85. The distributor 87 for appropriately distributing a refrigerant to the indoor units 83A and 83B is provided between a plurality of the indoor units 83A and 83B and the outdoor unit 85.

The operation signal generating unit 88 is provided in the distributor 87 of the unitary air conditioner in accordance with the fourth embodiment, thereby outputting signals to an operation controller 86 of the outdoor unit 85.

The multi-type unitary air conditioner comprising a plurality of the indoor units 83A and 83B needs to be operated in more complicated modes according to whether or not the indoor units 83A and 83B are respectively operated and the intensity of the operated indoor unit(s) 83A and/or 83B.

Accordingly, the operation signal generating unit 88 provided in the distributor 87 receives whether or not the indoor units 83A and 83B are respectively operated and operation conditions of the indoor units 83A and 83B through connection lines 91 connected to indoor unit controllers 84A and 84B of the indoor units 83A and 83B, and outputs a control signal according to the received results so that the air conditioner can be operated in a proper mode.

When Y1 and Y2 signals are transmitted through two connection lines of the conventional 2-stage unitary air conditioner, only Y1, Y2, and Y1+Y2 signals were generated. However, when the multi-type 2-stage unitary air conditioner of this embodiment is operated in an additional mode by allowing the operation signal generating unit 88 to adjust ON/OFF times through the Y1 connection line 92 or the Y2 connection line 93, the multi-type 2-stage unitary air conditioner can be operated in more various modes.

For example, when all the two indoor units 83A and 83b are operated in a strong mode as shown in FIG. 6, the operation signal generating unit 88 opens all refrigerant channels connected to the indoor units 83A and 83B and generates the Y2 signal through the Y2 connection line 93 so that the air conditioner is operated in a Y2 standard mode, and the operation controller 86 analyzes the signal and operates compressors of the outdoor unit 85 at the maximum capacity.

On the other hand, when one of the two indoor units 83A and 83b is operated, the operation signal generating unit 88 generates the Y1 signal through the Y1 connection line 92 so that the air conditioner is operated in a Y1 standard mode, and the operation controller 86 analyzes the signal and operates the compressors of the outdoor unit 85 at the minimum capacity.

Further, when one of the two indoor units 83A and 83B is operated in a weak mode and the other one of the two indoor units 83A and 83B is operated in a strong mode, the operation signal generating unit 88 generates a signal for adjusting ON/OFF times through the Y1 connection line 92 or the Y2 connection line 93 so that the air conditioner is operated in the additional mode, and the operation controller 86 operates the compressors of the outdoor unit 85 at an appropriate capacity between the maximum and minimum capacities.

The unitary air conditioner of the fourth embodiment is not limited thereto, but may be operated in various modes more than three modes by allowing the operation signal generating unit 88 to generate various signals through the Y1 connection line 92 and the Y2 connection line 93 in the same manner as the unitary air conditioner of the first embodiment.

A constitution of the unitary air conditioner of the fourth embodiment except for the above components, and a method for controlling the operation of the above unitary air conditioner are the same as those of the unitary air conditioner of the first embodiment, and a detailed description thereof will thus be omitted.

As apparent from the above description, the present invention provides an apparatus and a method for controlling the operation of a unitary air conditioner, which diversify signals to be transmitted using existing connection lines for transmitting signals by adjusting an interval between ON and OFF signals, etc., thereby allowing the unitary air conditioner to be operated in various modes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling the operation of a unitary air conditioner comprising:
an operation signal generating unit for outputting signals for controlling the operation of the unitary air conditioner corresponding to predetermined air conditioner modes using a switch-ON/OFF method; and
an operation controller for analyzing the signals of the operation signal generating unit and controlling the operation of the unitary air conditioner in a plurality of modes.

2. The apparatus as set forth in claim 1, wherein the operation signal generating unit outputs the signals corresponding to the air conditioner modes by the number of the ON and OFF signals which are repeated during a designated length of time.

3. The apparatus as set forth in claim 1, wherein the operation signal generating unit outputs the signals corresponding to the air conditioner modes by a difference of lengths of maintaining times between the ON and OFF signals which are repeated during a designated length of time.

4. The apparatus as set forth in claim 1, wherein the operation signal generating unit outputs the signals corresponding to the air conditioner modes by the length of time of the ON or OFF signal which is repeated during a designated length of time.

5. The apparatus as set forth in claim 1, wherein the operation signal generating unit is provided in at least one of a thermostat, an indoor unit, and a distributor of the unitary air conditioner.

6. The apparatus as set forth in claim 1, wherein the operation controller is provided in an outdoor unit of the unitary air conditioner.

7. The apparatus as set forth in claim 1, wherein the operation controller controls modes of compressors provided in an outdoor unit of the unitary air conditioner.

8. The apparatus as set forth in claim 1, further comprising one connection line connected between a thermostat or an indoor unit and an outdoor unit of the unitary air conditioner.

9. The apparatus as set forth in claim 1, further comprising two connection lines connected between a thermostat or an indoor unit and an outdoor unit of the unitary air conditioner.

10. An apparatus for controlling the operation of a unitary air conditioner comprising:
an operation signal generating unit for outputting signals for controlling the operation of the air conditioner corresponding to predetermined air conditioner modes using a switch-ON/OFF method;
an operation controller for analyzing the signals of the operation signal generating unit and controlling the operation of the unitary air conditioner in a plurality of modes; and
at least one connection line connected between the operation signal generating unit and the operation controller for transmitting the signals between the operation signal generating unit and operation controller.

11. The apparatus as set forth in claim 10, wherein the operation signal generating unit outputs the signals corresponding to the air conditioner modes by the number of the ON and OFF signals which are repeated during a designated length of time.

12. The apparatus as set forth in claim 10, wherein the operation signal generating unit outputs the signals corresponding to the air conditioner modes by a difference of lengths of maintaining times between the ON and OFF signals which are repeated during a designated length of time.

13. The apparatus as set forth in claim 10, wherein the operation signal generating unit outputs the signal corresponding to the air conditioner modes by the length of time of the ON or OFF signal which is repeated during a designated length of time.

14. The apparatus as set forth in claim 10, wherein the operation signal generating unit is provided in at least one of a thermostat, an indoor unit, and a distributor of the unitary air conditioner.

15. The apparatus as set forth in claim 10, wherein the operation controller is provided in an outdoor unit of the unitary air conditioner.

16. The apparatus as set forth in claim 10, wherein the operation controller controls modes of compressors provided in an outdoor unit of the unitary air conditioner.

17. A method for controlling the operation of a unitary air conditioner using the apparatus as set forth in claim 1, comprising:
allowing the operation controller to analyze an OFF signal, when the operation signal generating unit continuously outputs the OFF signal during more than a designated length of time, and to stop operation of compressors of the unitary air conditioner;
allowing the operation controller to analyze an ON signal, when the operation signal generating unit continuously outputs the ON signal during more than a designated length of time, and to operate the compressors in a standard mode; and
allowing the operation controller to analyze the ON and OFF signals, when the operation signal generating unit repeatedly outputs the ON and OFF signals during more than a designated length of time, and to operate the compressors in an additional mode.

18. The method as set forth in claim 17, wherein the operation signal generating unit outputs the signals corresponding to the air conditioner modes by the number of the ON and OFF signals which are repeated during a designated length of time.

19. The method as set forth in claim 17, wherein the operation signal generating unit outputs the signals corresponding to the air conditioner modes by an interval between the ON and OFF signals which are repeated during a designated length of time.

20. The method as set forth in claim 17, wherein the operation signal generating unit outputs the signals corresponding to the air conditioner modes by a difference of lengths of maintaining times between the ON and OFF signals which are repeated during a designated length of time.

21. The method as set forth in claim 17, wherein the operation signal generating unit outputs the signals corresponding to the air conditioner modes by the length of time of the ON or OFF signal which is repeated during a designated length of time.
